(19) United States
(12) Patent Application Publication
(10) Pub. No.: US 2024/0221030 A1
(43) Pub. Date: Jul. 4, 2024

(54) PREFERENTIAL THIRD-PARTY CONTENT MANAGEMENT

(71) Applicant: GOOGLE LLC, Mountain View, CA (US)

(72) Inventor: Prabhat Sharma, Mountain View, CA (US)

(21) Appl. No.: 18/225,242

(22) Filed: Jul. 24, 2023

Related U.S. Application Data
(60) Provisional application No. 63/478,139, filed on Dec. 31, 2022.

(51) Int. Cl. G06Q 30/0251; G06Q 30/0241

(52) U.S. Cl. CPC G06Q 30/0256; G06Q 30/0277

(57) ABSTRACT

To manage display of preferential third-party content a method includes receiving, from a first user device, one or more preferential signals obtained by the first user device via a content preference interface, wherein the preferential signals include indications of: (i) a preferential content description, (ii) an expiration time, (iii) a time of day window, and (iv) a preferential user device; receiving, by from the preferential user device, prior to the expiration time and during the time of day window, a query including a query content description identifying, (i) the preferential third-party content based on the preferential content description, and (ii) query third-party content based on the query content description; and causing the preferential user device to display, prior to the expiration time and during the time of day window, both the preferential third-party content and the query third-party content.

### CROSS-REFERENCE TO RELATED APPLICATIONS

This application claims the benefit of U.S. Provisional Patent Application No. 63/478,139, filed on Dec. 31, 2022, the entire disclosure of which is hereby incorporated by reference herein.

### FIELD OF THE DISCLOSURE

This disclosure relates to managing display of third-party content to a user and, more particularly, to managing display of preferential third-party content while displaying primary content.

### BACKGROUND

The existing techniques for selecting displaying third-party content for presentation with primary content (e.g., online advertisements embedded in web pages from content publishers) rely on a complex set of signals. For example, to select relevant third-party content for presentation within a content slot of a limited size on a web page, the existing techniques attempt to predict use behavior, preferences, and intent. On the other hand, the existing techniques for selecting query advertisements rely on a specific query from a user, and generally systems display query advertisements along with query results.

Neither of the two primary types of advertisements, display advertisements (based on prediction) and query advertisements (based on explicit intent) is always efficient. Display advertisements are generally constrained by predictions of user intent, and it is not always possible to generate an accurate estimate of the user intent. Conversely, an overly accurate estimate of user intent in some cases may appear intrusive. Query advertisements on the other hand are limited by the scope of the search query.

### SUMMARY

A user device can provide an interactive user interface for selecting preferential third-party content. The user can specify, via the interactive user interface, the type of the third-party content the user prefers to see and such parameters as for example the expiration time for the request, the time period during which the user would like to see the third-party content, and/or the device to which the network should direct the preferential third-party content.

An example embodiment of these techniques is a method for managing display of preferential third-party content. The method can be implemented in a computing system equipped with one or more processors and includes receiving, from a first user device, one or more preferential signals obtained by the first user device via a content preference interface, wherein the preferential signals include indications of: (i) a preferential content description, (ii) an expiration time, (iii) a time of day window, and (iv) a preferential user device; receiving, from the preferential user device, prior to the expiration time and during the time of day window, a query including a query content description; (3) identifying (i) the preferential third-party content based on the preferential content description, and (ii) query third-party content based on the query content description; and (4) causing the preferential user device to display, prior to the expiration time and during the time of day window, both the preferential third-party and the query third-party content.

### BRIEF DESCRIPTION OF THE DRAWINGS

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 is a block diagram of an example system which implements a method for managing display of preferential third-party content.

FIG. 2 illustrates an example user interface of a query with functionality to access a content preference interface.

FIG. 3 illustrates an example user interface for specifying preferences related to selection and presentation of third-party content;

FIG. 4 illustrates an example user interface for displaying preferential third-party content;

FIG. 5 is a block diagram of an example method for managing display of preferential third-party content.

### DETAILED DESCRIPTION

A system of this disclosure addresses the problems discussed above by identifying preferential third-party content based on one or more preferential signals, for which the system can provide a content preference interface, and by adjusting the selection of third-party content and the timing of presentation of this content according to these signals. In application to advertisements, the system can effectively bridge the gap between display advertisements and query advertisements. By selecting and providing preferential third-party content, a system can reduce the amount of third-party content presented to a user and reduce the amount of network traffic between a user device, content providers, content publishers, etc., as well as the amount of processing power expanded at these devices.

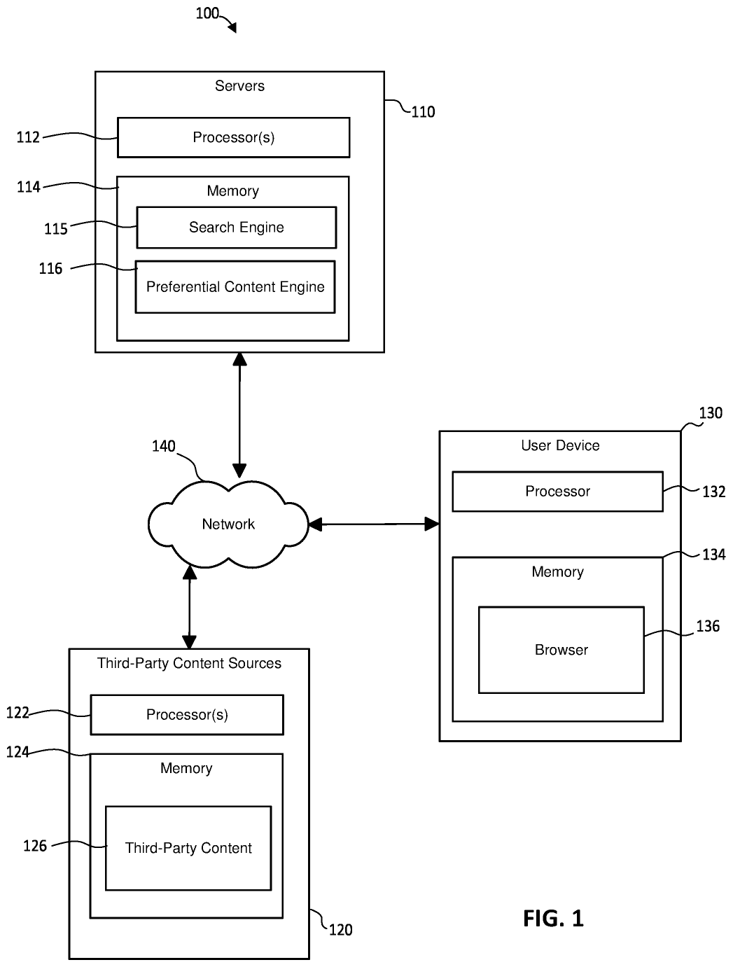

FIG. 1 illustrates a block diagram of an exemplary computing environment 100 in which the techniques of this disclosure may be implemented. The computing environment 100 may include one or more servers 110, one or more third-party content sources 120, and one or more user devices 130, communicatively coupled via a network 140 that may be of any suitable type (e.g., a wide area network such as the Internet, a local area network, a virtual private network). The network 140 can include any suitable number of wired and/or wireless communication links and any suitable number of network devices, such as gateways, switches, routers, modems, repeaters, and wireless access points, among others.

The one or more servers 110 can include or more processing modules 112 (e.g., general-purposes processors or specialized hardware) and memory modules 114 which may be located in a single geographic location, e.g., at a data center or a server farm, or distributed across a number of geographic locations. The one or more servers 110 can implement a search engine 115 and a preferential content engine 116, as a set of software instructions executable on the one or more processors 112. The one or more servers 110 can interact with any suitable number of databases.

As discussed in more detail, the preferential content engine 116 can receive signals indicating users' preferences and select preferential third-party content in accordance with these signals. For example, the preferential content engine 116 can receive signals via a dedicated user interface, process relevant queries, identify preferential third-party content, and cause the user devices 130 to display the preferential third-party content (simultaneously with other types of third-party content, for example). The one or more third-party content sources 120 provides, to the one or more servers 110, third-party content 126 that can include text, images, video, and/or audio components. After the user device 130 provides an indication of preferred third-party content, the preferential content engine 116 can determine which third-party content the server(s) 110 can provide the user device 130, and the timing of providing third-party content.

The user device 130 can be for example a personal computer, a smartphone, a tablet computer, a wearable electronic device, or similar mobile or stationary computing device capable of receiving and processing electronic information. In addition to one or more processors 132, such as a CPU, a GPU, etc., the user device 130 includes a memory 134 that stores software instructions executable by the one or more processors 132. Further, the user device 130 can include various sensors and input devices (none shown to reduce clutter) configured to determine the position of the user device 130, the orientation of the user device 130, detect various environmental factors, receive audio, visual, and tactile input, etc. The software instructions stored in the memory 134 can implement an operating system (OS) and various applications such as a browser 136.

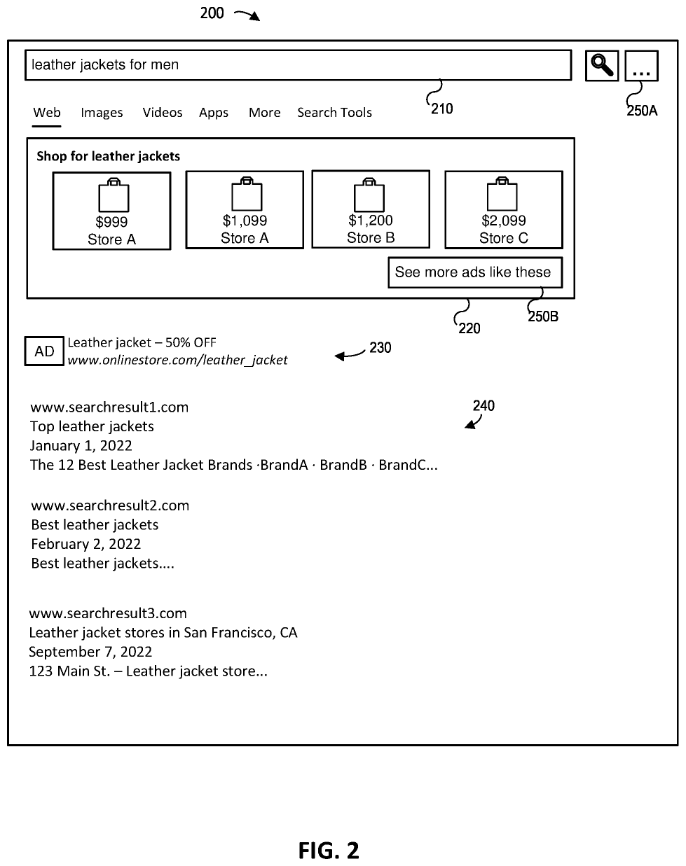

In operation, a user can provide preferential signals related to third-party content and receive the corresponding third-party content via the browser 136. Example interaction of the user device 130 with the server(s) 110 via the browser 136 is discussed next with reference to FIGS. 2-5.

FIG. 2 illustrates an example user interface screen 200 that includes third-party content displayed in response to a query 210 (in this case, “leather jackets for men”) and controls 250A and 250B for accessing a content preference selection functionality. The third-party content as illustrated includes sponsored advertisements 220 and 230, which the server 110 receives from the third-party content sources 120 and provides to the user device 130 along with the “organic” results 240 responsive to the query 210. Alternatively, the server 110 can provide links to the third-party content, and the user device 130 can retrieve the content 220 and 230 directly from the third-party content server(s) 120. In any case, the browser 136 can provide the user interface 200 after receiving the content 220, 230, and 240 in response to the query 210.

The screen 200 can include an input box 210 via which the user can input a query for the search engine 115. The screen 200 includes a listing of the search results 240, each of which can include a link, a description, an image (e.g., a thumbnail), etc. The screen 240 also includes sponsored advertisements 220 that may be in a format similar to the search result 240, or in a different format. The sponsored advertisements 220 can include images, videos, audio files, interactive maps, etc.

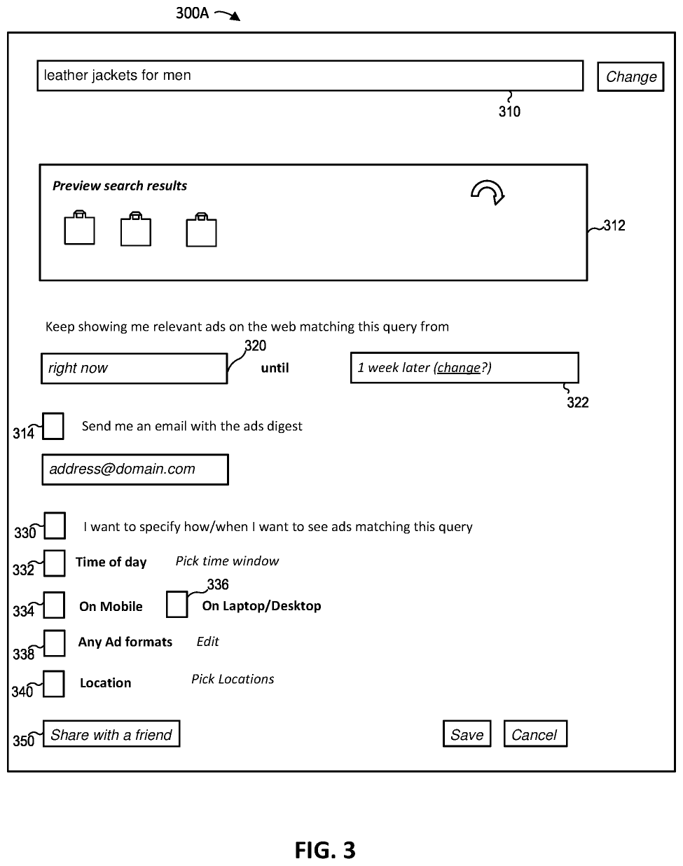

In response to the user actuating a control 250A or 250B, which may be a button or any other suitable control element, the user device 130 can present an interactive interface for requesting similar third-party content and, in at least some of the implementations, specifying various parameters related to selection and presentation of such content. One example of such interactive interface is considered next in connection with FIG. 3.

FIG. 3 illustrates an example user interface screen 300 for receiving preferential signals. When the user device 1130 accesses the search interface associated with the search engine 115, for example, the server(s) 110 can provide a script to the user device 130 such that actuating the control 250A or 250B (see FIG. 2) causes the browser 136 to display the screen 300. The user may choose to actuate the control 250A or 250B to specify parameters related to the third-party content 220 or 230, for example. Generally speaking, the user can operate various controls in the screen 300 to indicate the type of third-party content the user would like to receive from the server(s) 110 (e.g., the user may wish to see advertisements related to compact cars for the next month), the time when the user prefers to see such content (e.g., for the next month only, and only in the morning), the format in which the user prefers to receive the format (e.g., audio only, video and audio), the device(s) on which the user prefers to see the third-party content (e.g., smartphone only, laptop computer only, smartphone or laptop computer).

After the user specifies the preferences, the server(s) can adjust the selection and presentation of third-party content in connection with subsequent search queries or in another format (e.g., email, text messages) as discussed below. In some cases, where a subsequent query is unrelated to the third-party content to which the screen 300 applies, the server(s) can allocate a certain percentage of content item slots to the content of the screen 300. For example, the example screen 300 relates to the query for leather jackets for men, and the user can choose to see such ads for the next week. If the user's subsequent query is related to shoes, the server(s) can provide some third-party content related to shoes and other third-party content related to leather jackets, in accordance with the parameters the user provides via the screen 300.

Referring to FIG. 3, the screen 300 can include an input box 310 for specifying the query. In some implementations or scenarios, the screen 300 “inherits” the query from the input 210 of the screen 200, so that the user need not re-enter the search query. The screen 300 also can include a control 311 for modifying the query. Further, the user interface screen 300 can includes a preview area 312, in which the browser 136 can display example third-party content items; expiration controls 320 and 322 for limiting the period of time during which the user prefers to see the third-party content, which may be in a suitable format such as a list of predefined intervals (e.g., one week, two weeks, one month) or a calendar for specifying the exact dates; an email trigger 314 for requesting that the server(s) generate an email with the relevant third-party content or a digest of such content during the time window specified via the controls 320, 322; a switch 330 for displaying or hiding the controls 332-340 for specifying detailed parameters related to the mechanism and the timing of delivery; a time-of-day control for restricting presentation of third-party content to certain hours for example; radio buttons for selecting delivery of third-party content to a mobile device (control 334) or a laptop/desktop (control 336); a format selector 338; and a location selector 340 for limiting the presentation of third-party content to a certain geographic location, which can have any suitable level of granularity (e.g., city block, city, state, country). Still further, actuating the control 350 allows the user to select another user to whom the server 130 is to present the third-party content.

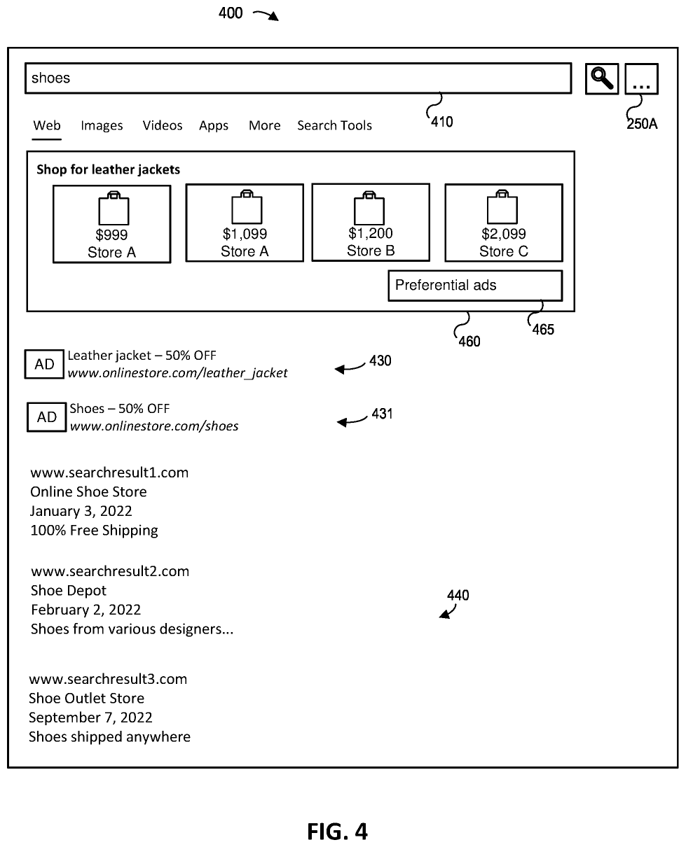

Now referring to FIG. 4, the server(s) 110 can cause the user device 130 to provide an example user interface 400 to display preferential third-party content. As illustrated in FIG. 4, the user in this scenario inputs the query “shoes” in an input box 410, and the server(s) 110 return organic results 440, each of the which is related to shoes, in response to this query. The server(s) 110 in this example also provide third-party content 430 and 460 related to leather jackets, in accordance with the preferential signals of the screen 300. The user in this example submits the query “shoes” at a time that falls within the window specified via the screen 300, and the server 110 determines that parameters specified for the preferential content related to leather jackets otherwise match the display of organic search results and third-party content related to shoes.

In some implementations, the third-party content in the screen 400 also can include advertisements 431 related to shoes. The preferential content engine 116 can rank third-party content items in any suitable manner, e.g., by assigning a larger weight to third-party content items related to the most recent query, and accordingly listing the corresponding items first.

As further illustrated in FIG. 4, the screen 400 can include a control element 465 for accessing a screen similar to the screen 300 of FIG. 3, to specify or modify preferences related to third-party content.

In some implementations, the one or more servers 110 determine one or more of the parameters discussed with reference to FIGS. 2-4, and/or additional parameters, automatically and based on implicit signals from the user. For example, the preferential content engine 116 can automatically determine the type of a device on which the user prefers to receive third-party content matching certain criteria. As a mores specific example, the user can indicate that the server should deliver third-party content items related to leather jackets during a relatively small window of time during which the user accesses the search engine 115 via the smartphone. The preferential content engine 116 in this case can automatically infer the value of the mobile/laptop parameter.

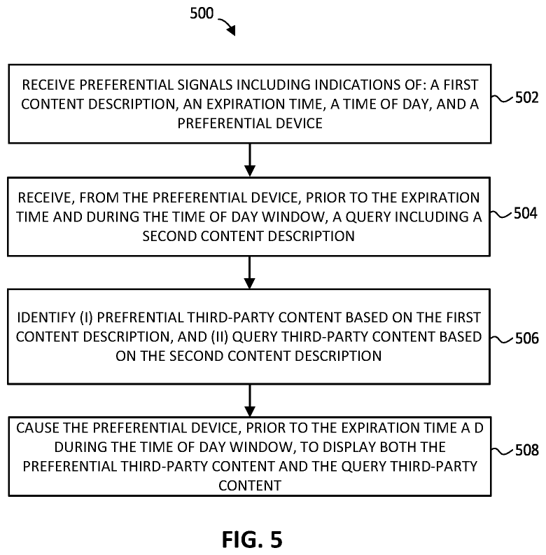

FIG. 5 is a flow diagram of an example method 500 for managing display of preferential third-party content. The method 500 can be implemented in the one or more servers 110. As a more specific example, the method 500 can be implemented in the preferential content engine 116. In another implementation, at least some of the acts of the method 500 can be implemented in the user device 130.

At block 502, the preferential content engine 116 receives preferential signals indicating how a user prefers to view third-party content of a certain kind. These signals can include a description of the first third-party content, a time of day, and a preferential device for presenting the third-party content. The description can include one or more keywords to which the third-party content must correspond, at any desired level of granularity, e.g., “cars,” “electric cars,” “compact electric cars.” In some implementations, the description includes the search query in connection with which the user invoked the interface for selecting preferential third-party content. The time of day window can include any suitable indication of an interval within a 24-our period, e.g., “9 am PST to 11 am PST,” or “morning.” In the latter case, the preferential content engine 116 can use further contextual signals to determine the boundaries of the morning time interval (e.g., using user-specific signals). As discussed above, a user interface such as the one discussed in connection with FIG. 3 can include a set of controls for receiving preferential signals from the user via the browser 136.

At block 504, the preferential content engine 116 can receive a query including a description of another content. The preferential content engine 116 receives this query within the specified time interval. The query can specify content other than the content specified at block 502. Referring to the examples of FIGS. 2-4, the preferential signals can correspond to “leather jackets” and the query at block 504 can correspond to “shoes.”

At block 506, the preferential content engine 116 identifies third-party content based on the query received at block 504, which can be referred to as “query third-party content,” as well as third-party content based on the preferential signals received at block 502, which can be referred to as the “preferential third-party content” (see, e.g., content items 430 and 431 in FIG. 4).

Finally, at block 508 the preferential content engine 116 causes the user device (e.g., the user devices 130) to display both the preferential third-party content and the query third-party content. The display of the preferential third-party content and the query third-party content in some implementations also is consistent with the preferential signals. For example, the browser 126 can receive, from the server(s) 110, instructions for displaying both the preferential third-party content and the query third-party content as a part of the same list or side-by-side within different respective frames on the web site, for example.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain aspects are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example aspects, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various aspects, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering aspects in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple such hardware modules exist contemporaneously, communications may be achieved through signal transmission (e.g., over appropriate circuits and buses) that connect the hardware modules. In aspects in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example aspects, comprise processor-implemented modules.

Similarly, methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example aspects, the processor or processors may be located in a single location (e.g., within a home environment, an office environment or as a server farm), while in other aspects the processors may be distributed across a number of locations.

The performance of certain of the operations may be distributed among the one or more processors, not only residing within a single machine, but deployed across a number of machines. In some example aspects, the one or more processors or processor-implemented modules may be located in a single geographic location (e.g., within a home environment, an office environment, or a server farm). In other example aspects, the one or more processors or processor-implemented modules may be distributed across a number of geographic locations.

Unless specifically stated otherwise, discussions herein using words such as “processing.” “computing.” “calculating.” “determining.” “presenting.” “displaying.” “ingesting,” “generating,” “causing,” “analyzing.” “adjusting.” “receiving.” “obtaining.” “identifying.” “causing.” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one aspect” or “an aspect” means that a particular element, feature, structure, or characteristic described in connection with the aspect is included in at least one aspect. The appearances of the phrase “in one aspect” in various places in the specification are not necessarily all referring to the same aspect.

Some aspects may be described using the expression “coupled” and “connected” along with their derivatives. For example, some aspects may be described using the term “coupled” to indicate that two or more elements are in direct physical or electrical contact. The term “coupled,” however, may also mean that two or more elements are not in direct contact with each other, but yet still co-operate or interact with each other. The aspects are not limited in this context.

As used herein, the terms “comprises,” “comprising.” “includes,” “including.” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of aspects herein. This is done merely for convenience and to give a general sense of the description. This description, and the claims that follow, should be read to include one or at least one and the singular also includes the plural unless it is obvious that it is meant otherwise.

This detailed description is to be construed as exemplary only and does not describe every possible aspect, as describing every possible aspect would be impractical, if not impossible. One could implement numerous alternate aspects, using either current technology or technology developed after the filing date of this application.

Upon reading this disclosure, those of skill in the art will appreciate still additional alternative structural and functional designs for systems and methods according to the disclosed principles herein. Thus, while particular aspects and applications have been illustrated and described, it is to be understood that the disclosed aspects are not limited to the precise construction and components disclosed herein. Various modifications, changes and variations, which will be apparent to those skilled in the art, may be made in the arrangement, operation and details of methods and apparatuses disclosed herein without departing from the spirit and scope defined in the appended claims.

1. A method for managing display of preferential third-party content, comprising:
receiving, by one or more processors of a server from a first user device, one or more preferential signals provided by a user obtained by the first user device via a content preference interface, wherein the preferential signals indicate content characteristics preferred by the user, including: (i) a preferential content description, (ii) an expiration time, (iii) a time of day window, and (iv) a preferential user device;
receiving, by the one or more processors of the server from the preferential user device, prior to the expiration time and during the time of day window, a query including a query content description;
identifying, by the one or more processors of the server, (i) the preferential third-party content based on the preferential content description, and (ii) query third-party content based on the query content description;
transmitting, by the one or more processors of the server to the preferential user device, the identified preferential third-party content; and
causing, by the one or more processors of the server, the preferential user device to display to the user, prior to the expiration time and during the time of day window, both the preferential third-party content and the query third-party content.

2. The method of claim 1, further comprising:
receiving, by the one or more processors of the server from the first user device, an original query corresponding to the preferential content description; and
causing, by the one or more processors of the server, the first user device to display original query third-party content corresponding to the preferential content description.

3. The method of claim 1, further comprising:
receiving, by the one or more processors of the server, one or more display signals indicating one or more display content descriptions;
identifying, by the one or more processors of the server, display third-party content based on the display content descriptions;
determining, by the one or more processors of the server, a priority order between each of the preferential signals, the display signals, and query signals indicating the query content description; and
causing, by the one or more processors of the server, the preferential user device to display, in accordance with the determined priority order, prior to the expiration time and during the time of day window, the preferential third-party content, the query third-party content, and the display third-party content.

4. The method of claim 1, further comprising:
receiving, by the one or more processors of the server, a share request obtained from the user of the first user device to share the preferential signal with a second user;
identifying, by the one or more processors of the server, a second user device associated with the second user;
identifying, by the one or more processors of the server, shared third-party content based on the preferential content description of the preferential signal; and
causing, by the one or more processors of the server, the second user device to display, prior to the expiration time and during the time of day window, the shared third-party content.

5. The method of claim 4, wherein the shared third-party content is the same as the preferential third-party content.

6. The method of claim 1, wherein the preferential user device displays the preferential third-party content in a first window, further comprising:
causing, by the one or more processors of the server, the preferential user device to also display in the first window, a preferential marker corresponding to the preferential third-party content.

7. The method of claim 1, wherein the preferential signals further include an indication of a format and wherein the preferential third-party content is in accordance with the format.

8. The method of claim 1, wherein the preferential user device is the first user device.

9. The method of claim 1, wherein the preferential user device is a different type of user device than the first user device.

10. A computing system, comprising:
a first user device configured to receive inputs from a user;
a preferential user device configured to receive inputs from the user and display contents to the user, wherein the preferential user device is a distinct device from the first user device; and
a server remotely connected to the first user device and the preferential user device via a network, the server configured to:
receive, from the first user device, one or more preferential signals provided by the user obtained by the first user device via a content preference interface, wherein the preferential signals indicate content characteristics preferred by the user, including: (i) a preferential content description, (ii) an expiration time, (iii) a time of day window, and (iv) the preferential user device;
receive, from the preferential user device, prior to the expiration time and during the time of day window, a query including a query content description;
identify (i) preferential third-party content based on the preferential content description, and (ii) query third-party content based on the query content description;
transmit, to the preferential user device, the identified preferential third-party content; and
cause the preferential user device to display to the user, prior to the expiration time and during the time of day window, both the preferential third-party content and the query third-party content.

11. The computing system of claim 10, wherein the server is configured to:
receive, from the first user device, an original query corresponding to the preferential content description; and
cause the first user device to display original query third-party content corresponding to the preferential content description.

12. The computing system of claim 10, wherein the the server is configured to:
receive one or more display signals indicating one or more display content descriptions;
identify display third-party content based on the display content descriptions;
determine a priority order between each of the preferential signals, the display signals, and priority signals indicating the query content description; and
cause the preferential user device to display, in accordance with the determined priority order, prior to the expiration time and during the time of day window, the preferential third-party content, the query third-party content, and the display third-party content.

13. The computing system of claim 10, wherein the the server is configured to:
receive a share request obtained from the user of the first user device, to share the preferential signals with a second user;
identify a second user device associated with the second user;
identify shared third-party content based on the preferential content description of the preferential signals; and
cause the second user device to display, prior to the expiration time and during the time of day window, the shared third-party content.

14. The computing system of claim 10, wherein the preferential user device displays the preferential third-party content in a first window and the server is configured to:
cause the preferential user device to also display in the first window, a preferential marker corresponding to the preferential third-party content.

15. The computing system of claim 10, wherein the preferential signals further include an indication of a format and wherein the preferential third-party content is in accordance with the format.

16. One or more tangible, non-transitory computer-readable media storing executable instructions for managing display of preferential third-party content that when executed by one or more processors of a server, cause the one or more processors of the server to:
receive, from a first user device, one or more preferential signals provided by a user obtained by the first user device via a content preference interface, wherein the preferential signals indicate content characteristics preferred by the user, including: (i) a preferential content description, (ii) an expiration time, (iii) a time of day window, and (iv) a preferential user device;
receive, from the preferential user device, prior to the expiration time and during the time of day window, a query including a query content description;
identify (i) the preferential third-party content based on the preferential content description, and (ii) query third-party content based on the query content description;
transmit, to the preferential user device, the identified preferential third-party content; and
cause the preferential user device to display to the user, prior to the expiration time and during the time of day window, both the preferential third-party content and the query third-party content.

17. The one or more tangible, non-transitory computer-readable media of claim 16 storing further executable instructions for managing display of the preferential third-party content that when executed, cause the one or more processors of the server to:
receive, from the first user device, an original query corresponding to the preferential content description; and
causing the first user device to display original query third-party content corresponding to the preferential content description.

18. The one or more tangible, non-transitory computer-readable media of claim 16 storing further executable instructions for managing display of the preferential third-party content that when executed, cause the one or more processors of the server to:
receive one or more display signals indicating one or more display content descriptions;
identify display third-party content based on the display content descriptions;
determine a priority order between each of the preferential signals and the display signals; and
cause the preferential user device to display simultaneously with the query third-party content, prior to the expiration time and during the time of day window, the preferential third-party content and the display third-party content in accordance with the priority order.

19. The one or more tangible, non-transitory computer-readable media of claim 16 storing further executable instructions for managing display of the preferential third-party content that when executed, cause the one or more processors of the server to:
receive a share request obtained from the user of the first user device to share the preferential signal with a second user;
identify a second user device associated with the second user;
identify shared third-party content based on the preferential content description of the preferential signal; and
cause the second user device to display, prior to the expiration time and during the time of day window, the shared third-party content.

20. The one or more tangible, non-transitory computer-readable media of claim 16 wherein the preferential user device displays the preferential third-party content in a first window, storing further executable instructions for managing display of preferential third-party content that when executed, cause the one or more processors of the server to:
cause the preferential user device to also display in the first window, a preferential marker corresponding to the preferential third-party content.
